(19) United States
(12) Patent Application Publication
(10) Pub. No.: US 2017/0106471 A1
(43) Pub. Date: Apr. 20, 2017

(54) LASER PROCESSING APPARATUS

(71) Applicant: DISCO CORPORATION, Tokyo (JP)

(72) Inventors: Shungo Yoshii, Tokyo (JP); Junichi Kuki, Tokyo (JP); Kana Aida, Tokyo (JP)

(21) Appl. No.: 15/293,587

(22) Filed: Oct. 14, 2016

(30) Foreign Application Priority Data
Oct. 20, 2015 (JP) 2015-206227

(51) Int. Cl. B23K 26/142; B23K 26/402; B23K 26/00; B23K 26/364

(52) U.S. Cl. CPC B23K 26/142; B23K 26/364; B23K 26/402; B23K 26/009; B23K 2203/56

(57) ABSTRACT

A laser processing apparatus ablates the upper surface of a plate-shaped workpiece by using a laser beam passed through a water-soluble protective film formed on the upper surface of the plate-shaped workpiece. A nozzle applies the laser beam to the upper surface of the plate-shaped workpiece. The processing nozzle includes a debris capturing chamber for capturing debris scattering due to the application of the laser beam. A capturing space is defined in the debris capturing chamber, and an air discharge port and a suction port are opposed to each other in the capturing space. Air is discharged from the air discharge port toward the suction port so as to produce an air flow perpendicular to the optical path of the laser beam, so that the debris is sucked into the suction port by this air flow.

### BACKGROUND OF THE INVENTION

Field of the Invention

The present invention relates to a laser processing apparatus including a processing nozzle for removing debris.

Description of the Related Art

Conventionally, ablation is known as a kind of processing for forming a processed groove on a plate-shaped workpiece by applying a pulsed laser beam having an absorption wavelength to the plate-shaped workpiece to thereby sublime a part of the plate-shaped workpiece. In this ablation, there is a problem such that debris is generated due to melting of the plate-shaped workpiece in forming the processed groove, and this debris scatters as particles and next adheres to the upper surface of the plate-shaped workpiece, causing a degradation in quality. To cope with this problem, there has been proposed a method including the steps of covering the upper surface of the plate-shaped workpiece with a protective film, applying a laser beam through the protective film to the plate-shaped workpiece to thereby perform ablation, depositing the debris on the protective film, and removing the debris together with the protective film (see Japanese Patent No. 4993886, for example).

In this case, the protective film is also processed by the laser beam. However, since the focal point of the laser beam is set inside the plate-shaped workpiece, the laser beam is not focused in the protective film. Accordingly, the protective film is not burned, but melted by the laser beam, so that the adhesion of the debris to the plate-shaped workpiece can be prevented. Further, there has been proposed a method for preventing the laser beam from being interrupted by the debris scattering in performing ablation. For example, known is a method of discharging air along the optical path of the laser beam to thereby blow away the debris from the processed groove (see Japanese Patent Laid-open Nos. 2012-30235 and 2012-24831, for example). Further also known is a method of increasing the beam power or the number of passes of the laser beam (the number of times the laser beam is scanned).

### SUMMARY OF THE INVENTION

In the method described in Japanese Patent Laid-open Nos. 2012-30235 and 2012-24831, however, there is a case that the debris blown away from the processed groove may adhere again to the processed groove or may adhere to a processing nozzle to interrupt the optical path of the laser beam. Further, the beam power or the number of passes of the laser beam may be increased to form a processed groove having a proper depth regardless of the condition that the debris is slightly left in the optical path of the laser beam. However, when the beam power or the number of passes of the laser beam is increased, processing heat is transferred to the plate-shaped workpiece to cause damage to each device.

It is therefore an object of the present invention to provide a laser processing apparatus which can improve the processability without increasing the beam power or the number of passes of the laser beam.

In accordance with an aspect of the present invention, there is provided a laser processing apparatus for applying a laser beam to the upper surface of a plate-shaped workpiece, thereby performing ablation, the upper surface of the plate-shaped workpiece being covered with a water-soluble protective film, the laser processing apparatus including a chuck table for holding the plate-shaped workpiece; focusing means for focusing the laser beam to the plate-shaped workpiece held on the chuck table; and a processing nozzle for applying the laser beam focused by the focusing means to the upper surface of the plate-shaped workpiece in a direction perpendicular thereto and removing debris from the upper surface of the plate-shaped workpiece; the processing nozzle including a laser beam passage for allowing the pass of the laser beam focused by the focusing means and the application of the laser beam to the upper surface of the plate-shaped workpiece in the direction perpendicular thereto; and debris removing means for removing the debris scattering from the plate-shaped workpiece due to the application of the laser beam passed through the laser beam passage; the debris removing means including a debris capturing chamber composed of an upper wall in which the laser beam passage is formed, a side wall formed so as to depend from the upper wall, and a lower wall opposed to the upper wall and having an opening for capturing the debris; a suction port for connecting the debris capturing chamber to a vacuum source; and an air discharge port for discharging air toward the suction port in such a manner that the air flows across the optical path of the laser beam in a direction perpendicular thereto in the range from the laser beam passage to the opening; whereby the air is discharged from the air discharge port and the debris is sucked into the suction port by an air flow produced in the debris capturing chamber.

With this arrangement, the laser beam is applied through the laser beam passage of the processing nozzle to the upper surface of the plate-shaped workpiece, and the air is discharged from the air discharge port in the direction perpendicular to the optical path of the laser beam in the debris capturing chamber. The air discharged from the air discharge port flows across the optical path of the laser beam in the range of the laser beam passage to the opening of the lower wall. Accordingly, an air flow is produced along the upper surface of the plate-shaped workpiece so as to be directed from the air discharge port toward the suction port. The debris scattering from the plate-shaped workpiece due to the application of the laser beam is sucked into the suction port by this air flow, so that the optical path of the laser beam is not interrupted by the debris in the debris capturing chamber. Accordingly, the beam power or the number of passes of the laser beam is not required to be increased, thereby improving the processability. Further, the periphery of a work point where the laser beam is applied is covered with the debris capturing chamber, and the debris is sucked near the periphery of the work point, so that the debris does not scatter around the processing nozzle.

Preferably, the air is discharged from the air discharge port at a flow velocity of 500 m/second to 600 m/second.

According to the present invention, the debris scattering from the plate-shaped workpiece due to the application of the laser beam is blown away in the direction perpendicular to the optical path of the laser beam, so that the optical path of the laser beam is not interrupted by the debris. Accordingly, the processability can be improved without increasing the beam power or the number of passes of the laser beam.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a laser processing apparatus according to a preferred embodiment of the present invention;

FIG. 2 is a sectional view of a processing nozzle and suction equipment according to a comparison;

FIG. 3 is a perspective view of a processing head included in the laser processing apparatus shown in FIG. 1;

FIG. 4 is a sectional view of the processing head shown in FIG. 3; and

FIGS. 5A to 5C are sectional views for illustrating a laser processing operation by the processing head shown in FIG. 4.

### DETAILED DESCRIPTION OF THE PREFERRED EMBODIMENT

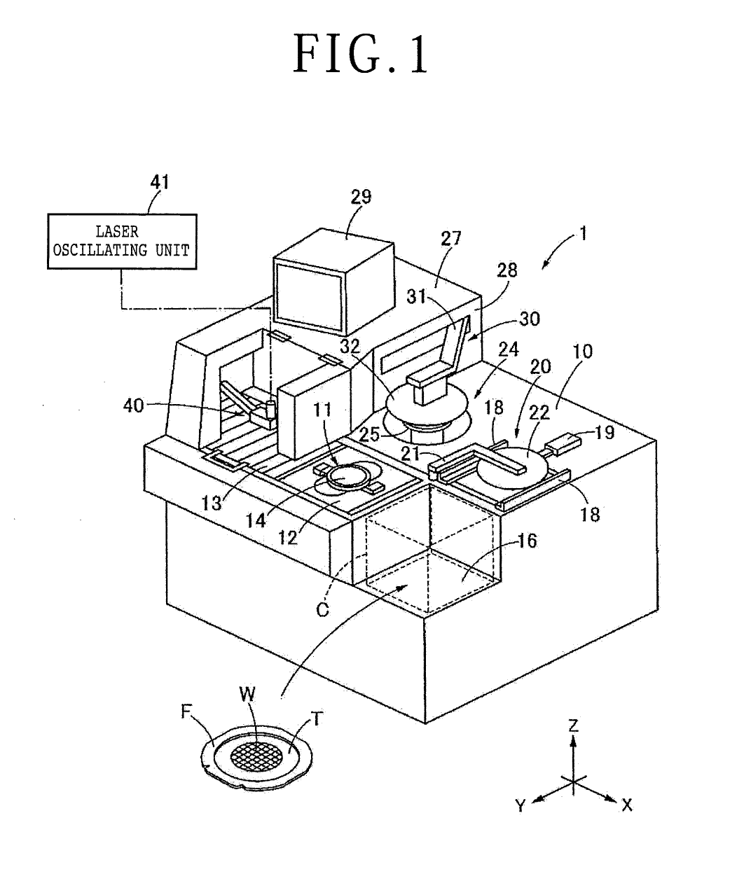

A preferred embodiment of the present invention will now be described with reference to the attached drawings. FIG. 1 is a perspective view of a laser processing apparatus 1 according to this preferred embodiment. The laser processing apparatus 1 shown in FIG. 1 is merely illustrative and the configuration thereof may be suitably changed so as to allow ablation to a plate-shaped workpiece.

As shown in FIG. 1, the laser processing apparatus 1 includes a chuck table 11 for holding a plate-shaped workpiece W and a processing head 40 for applying a laser beam to the front side (upper surface) of the plate-shaped workpiece W held on the chuck table 11, thereby performing ablation to the plate-shaped workpiece W. The front side of the plate-shaped workpiece W is partitioned by a plurality of crossing division lines to define a plurality of separate regions where a plurality of devices are formed. An adhesive tape T is attached at its central portion to the back side (lower surface) of the plate-shaped workpiece W, and the peripheral portion of the adhesive tape T is attached to an annular frame F. Accordingly, the plate-shaped workpiece W is supported through the adhesive tape T to the annular frame F in the condition where the front side of the plate-shaped workpiece W is exposed. The plate-shaped workpiece W may be a semiconductor wafer formed of silicon, gallium arsenide, and so on or may be an optical device wafer formed of ceramic, glass, sapphire, and so on.

The term of “ablation” used herein means a phenomenon such that when the intensity of a laser beam applied becomes equal to or greater than a predetermined processing threshold, the energy of the laser beam is converted into electronic, thermal, photochemical, and mechanical energy on the surface of a solid, so that neutral atoms, molecules, positive and negative ions, radicals, clusters, electrons, and light are exposively emitted and the solid surface is etched.

The laser processing apparatus 1 includes a housing 10. The upper surface of the housing 10 is formed with a rectangular opening extending in the X axis direction shown by an arrow X in FIG. 1. This opening is closed by the chuck table 11, a movable plate 12, and a bellows-shaped waterproof cover 13. The movable plate 12 and the bellows-shaped waterproof cover 13 are movable together with the chuck table 11. Although not shown, a ball screw type moving mechanism for moving the chuck table 11 in the X axis direction is provided below the waterproof cover 13. The upper surface of the chuck table 11 is formed with a holding surface 14 for holding the plate-shaped workpiece W under suction. The holding surface 14 is formed of a porous ceramic material. The holding surface 14 is connected to a vacuum source (not shown) through a suction passage formed in the chuck table 11, so that a vacuum produced from the vacuum source is applied to the holding surface 14 to hold the plate-shaped workpiece W through the adhesive tape T on the holding surface 14 under suction.

The chuck table 11 is movable in the X axis direction between a standby position set at the center of the apparatus 1 in the X axis direction and a working position below the processing head 40. FIG. 1 shows a condition that the chuck table 11 is in the standby position. The housing 10 has a corner portion formed adjacent to the standby position in the X axis direction. This corner portion is lowered to provide a vertically movable mounting table 16 for mounting a cassette C in which the plate-shaped workpiece S is stored. When the mounting table 16 is vertically moved in the condition where the cassette C is mounted thereon, the vertical position of the plate-shaped workpiece W in the cassette C is adjusted in pulling the plate-shaped workpiece W out of the cassette C or pushing it into the cassette C.

A pair of parallel centering guides 18 extending in the Y axis direction shown by an arrow Y in FIG. 1 are provided on the rear side of the mounting table 16. Further, a push-pull mechanism 19 is also provided on the rear side of the mounting table 16 to push and pull the plate-shaped workpiece W between the centering guides 18 and the cassette C mounted on the mounting table 16. Accordingly, the plate-shaped workpiece W is pulled or pushed with respect to the cassette C by the push-pull mechanism 19 and this push-pull operation is guided by the centering guides 18. At the same time, the plate-shaped workpiece W is positioned in the X axis direction by the centering guides 18. That is, the plate-shaped workpiece W is centered between the centering guides 18 in the X axis direction. More specifically, the plate-shaped workpiece W is pulled out of the cassette C and carried to the centering guides 18 by the push-pull mechanism 19 before processing, whereas the plate-shaped workpiece W is pushed from the centering guides 18 into the cassette C by the push-pull mechanism 19 after processing.

A first transfer arm 20 is provided in the vicinity of the centering guides 18 to transfer the plate-shaped workpiece W between the centering guides 18 and the chuck table 11. The first transfer arm 20 includes an L-shaped arm portion 21 and a suction pad 22 provided at the front end of the arm portion 21. The arm portion 21 of the first transfer arm 20 is adapted to be horizontally rotated, and the suction pad 22 can hold the plate-shaped workpiece W under suction. Accordingly, the plate-shaped workpiece W held by the suction pad 22 can be transferred by the rotation of the arm portion 21. A spinner cleaning mechanism 24 is provided on the rear side of the chuck table 11 in its standby position. The spinner cleaning mechanism 24 includes a spinner table 25 for holding the plate-shaped workpiece W thereon. The spinner cleaning mechanism 24 is adapted to spray a cleaning water toward the spinner table 25 being rotated, thereby cleaning the plate-shaped workpiece W held on the spinner table 25. Further, the spinner cleaning mechanism 24 is adapted to blow dry air toward the spinner table 25 after cleaning the plate-shaped workpiece W, thereby drying the plate-shaped workpiece W held on the spinner table 25.

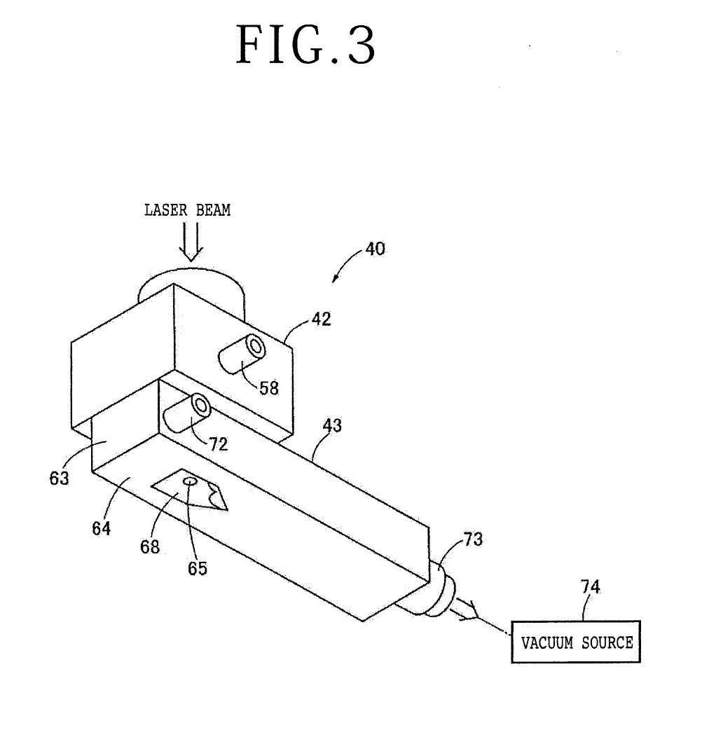

A support base 27 is provided on the upper surface of the housing 10 to support the processing head 40 for laser processing the plate-shaped workpiece W. A laser oscillating unit 41 for oscillating a laser beam is connected to the processing head 40. The processing head 40 includes focusing means 42 (see FIG. 3) for focusing the laser beam oscillated from the laser oscillating unit 41 and a processing nozzle 43 (see FIG. 3) for applying the laser beam focused by the focusing means 42 to the upper surface of the plate-shaped workpiece W in a direction perpendicular thereto. The direction perpendicular to the upper surface of the plate-shaped workpiece W means not only the direction perfectly perpendicular to the upper surface of the plate-shaped workpiece W, but also the direction substantially perpendicular to the upper surface of the plate-shaped workpiece W such that the optical path of the laser beam is slightly inclined with respect to the normal to the upper surface of the plate-shaped workpiece W. That is, it is only essential to focus the laser beam at a desired depth from the upper surface of the plate-shaped workpiece W. A moving mechanism (not shown) for moving the processing nozzle 43 in the Y axis direction and the Z axis direction (shown by an arrow Z in FIG. 1) is connected to the processing head 40.

A second transfer arm 30 is provided on the side surface 28 of the support base 27 to transfer the plate-shaped workpiece W between the chuck table 11 and the spinner cleaning mechanism 24. The second transfer arm 30 includes an arm portion 31 obliquely extending from the side surface 28 toward the front side of the apparatus 1 and a suction pad 32 provided at the front end of the arm portion 31. The arm portion 31 of the second transfer arm 30 is adapted to be moved in the Y axis direction, and the suction pad 32 can hold the plate-shaped workpiece W under suction. Accordingly, the plate-shaped workpiece W held by the suction pad 32 can be transferred by the movement of the arm portion 31. A monitor 29 is mounted on the upper surface of the support base 27 to display processing conditions or the like. In this laser processing apparatus 1, the laser beam is applied from the processing nozzle 43 (see FIG. 3) to each division line of the plate-shaped workpiece W, and the chuck table 11 is moved relative to the processing nozzle 43 to thereby form a processed groove on the upper surface of the plate-shaped workpiece W along each division line.

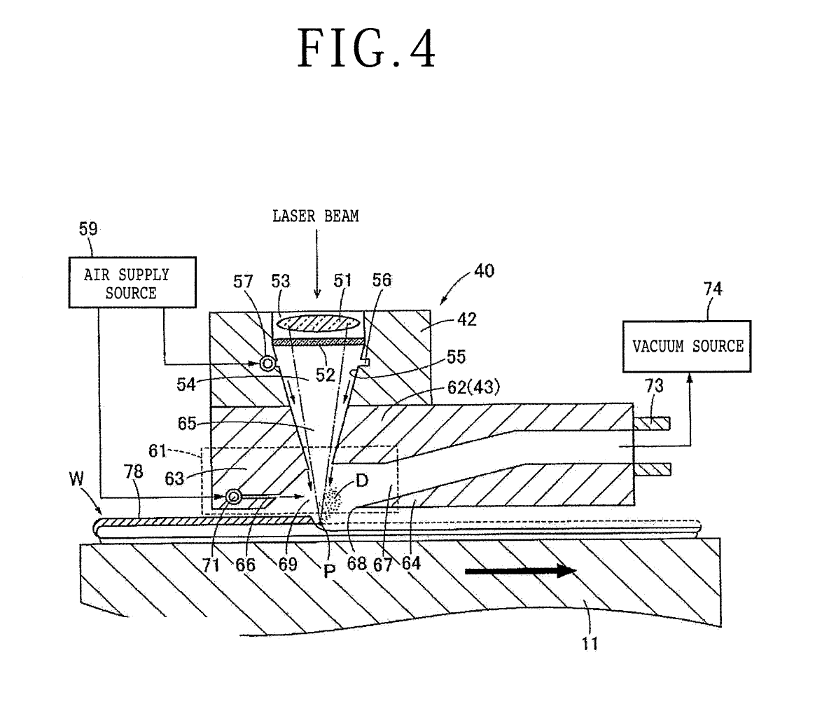

The upper surface of the plate-shaped workpiece W is covered with a water-soluble protective film 78 (see FIG. 4) for preventing the adhesion of debris generated due to melting of a part of the plate-shaped workpiece W in performing ablation. For example, polyvinyl alcohol (PVA) or polyethylene glycol (PEG) may be used as the water-soluble protective film 78. By forming the water-soluble protective film 78 on the upper surface of the plate-shaped workpiece W, the debris generated from the plate-shaped workpiece W adheres to the water-soluble protective film 78, so that the adhesion of the debris to the upper surface of the plate-shaped workpiece W in ablation can be prevented. After laser processing, a cleaning water is sprayed to the plate-shaped workpiece W by the spinner cleaning mechanism 24, thereby removing the water-soluble protective film 78 and the debris from the plate-shaped workpiece W.

Generally in performing ablation, there is a case that the debris scattering from the upper surface of the plate-shaped workpiece W may interrupt the laser beam to cause a reduction in processability. In this case, the effect of the debris scattering from the upper surface of the plate-shaped workpiece W may be reduced by blowing air from the processing nozzle along the optical path of the laser beam or by increasing the beam power or the number of passes of the laser beam. However, in the method of blowing air along the optical path of the laser beam, there is a case that the debris rising due to the air may interrupt the optical path of the laser beam again. Further, in the method of increasing the beam power or the number of passes of the laser beam in the condition where the processing energy of the laser beam has been reduced to form a shallow processed groove, there is a problem that damage to each device is large.

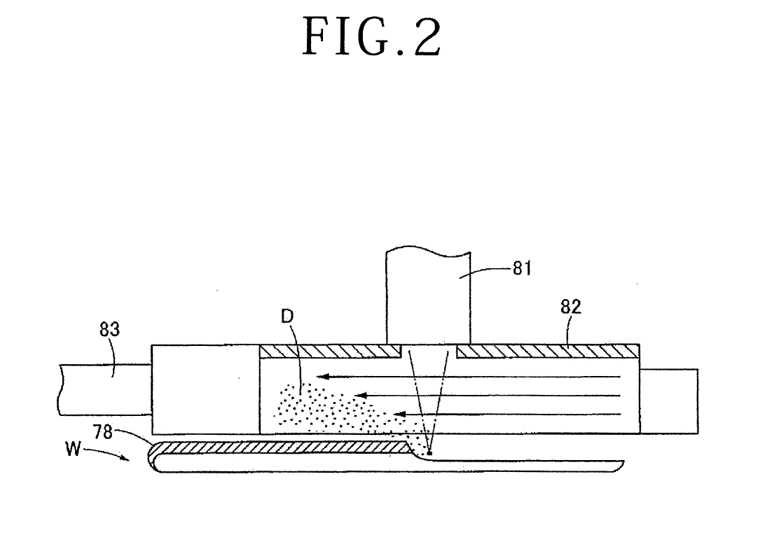

FIG. 2 shows a processing nozzle 81 and suction equipment 82 as a comparison. The suction equipment 82 is mounted to the lower end of the processing nozzle 81 and provided so as to cover the upper surface of the plate-shaped workpiece W. In the suction equipment 82, an air flow is produced along the upper surface of the plate-shaped workpiece W. In this comparison, debris D scattering from the upper surface of the plate-shaped workpiece W rides the air flow to enter an air outlet duct 83 included in the suction equipment 82. Accordingly, the optical path of the laser beam is not interrupted by the debris D, so that the processability to the plate-shaped workpiece W is not reduced. However, this configuration shown in FIG. 2 has a problem such that a large amount of air is consumed during ablation and the suction equipment 82 having a large size must be mounted to the lower end of the processing nozzle 81.

To cope with this problem, the processing nozzle 43 according to this preferred embodiment is formed with a debris capturing chamber 61 (see FIG. 4), thereby producing an air flow along the upper surface of the plate-shaped workpiece W at a position directly above a work point and simultaneously applying the laser beam to the plate-shaped workpiece W. According to this preferred embodiment, the debris D can be removed from the optical path of the laser beam by using a small amount of air to thereby prevent a reduction in processability to the plate-shaped workpiece W. Further, the large-sized suction equipment 82 (see FIG. 2) as covering the upper side of the plate-shaped workpiece W is not required to be mounted to the lower end of the processing nozzle 43, so that the configuration for removing the debris D can be simplified. Further, since the laser beam is not interrupted by the debris D, it is unnecessary to increase the beam power or the number of passes of the laser beam, thereby preventing damage to each device.

The processing head 40 will now be described in more detail with reference to FIGS. 3 and 4. FIG. 3 is a perspective view of the processing head 40, and FIG. 4 is a sectional view of the processing head 40.

As shown in FIGS. 3 and 4, the processing head 40 includes the focusing means 42 and the processing nozzle 43 mounted on the lower surface of the focusing means 42. The laser beam focused by the focusing means 42 is applied from the processing nozzle 43 to the plate-shaped workpiece W. At the same time, the debris D scattering from the plate-shaped workpiece W is removed by the processing nozzle 43. The focusing means 42 includes a focusing lens 51 and a protective cover glass 52 for protecting the focusing lens 51 from the debris D generated in ablation. There is defined an inside space in the focusing means 42, wherein this inside space is partitioned by the protective cover glass 52 to define a cylindrical upper space 53 where the focusing lens 51 is provided and an inverted frustoconical lower space 54 as a passage for the laser beam focused by the focusing lens 51.

The lower space 54 of the focusing means 42 is defined by an inner circumferential surface 55. An annular groove 56 is formed on the inner circumferential surface 55. An air supply passage 57 is in communication with the annular groove 56. The air supply passage 57 is connected through an air pipe (not shown) to an air supply source 59. This air pipe is connected to a connecting portion 58 projecting from one outer side surface of the focusing means 42. Accordingly, air is supplied from the air supply source 59 through the air supply passage 57 to the annular groove 56. The air is next allowed to flow along the annular groove 56 and flow downward along the inner circumferential surface 55 of the focusing means 42, thus forming an air flow along the optical path of the laser beam. The protective cover glass 52 is formed of a material that can transmit the laser beam. The material of the protective cover glass 52 is suitably selected according to the wavelength of the laser beam, for example.

The processing nozzle 43 has an upper wall 62. The upper wall 62 is formed with a laser beam passage 65 for allowing the pass of the laser beam focused by the focusing means 42 and the application of the laser beam to the upper surface of the plate-shaped workpiece W. The laser beam passage 65 has an inverted frustoconical shape continuing to the shape of the lower space 54 of the focusing means 42. The laser beam passage 65 also functions in combination with the lower space 54 to pass the air flow along the optical path of the laser beam and discharge air toward a work point P. The laser beam passage 65 has a narrow outlet opening, thereby increasing the flow velocity of air to be discharged from the outlet opening of the laser beam passage 65. Due to the air to be discharged from the outlet opening of the laser beam passage 65, it is possible to prevent the debris D from entering the focusing means 42 through the laser beam passage 65, thereby suppressing the adhesion of the debris D to the protective cover glass 52.

The processing nozzle 43 includes debris removing means for removing the debris D scattering from the plate-shaped workpiece W due to the application of the laser beam passed through the laser beam passage 65. The debris removing means includes the debris capturing chamber 61 mentioned above, an air discharge port 66 formed in the debris capturing chamber 61, and a suction port 67 formed in the debris capturing chamber 61 so as to be opposed to the air discharge port 66 in a direction perpendicular to the optical path of the laser beam. With this arrangement, an air flow is produced along the upper surface of the plate-shaped workpiece W (water-soluble protective film 78) at a position directly above the work point P. The debris capturing chamber 61 is composed of the upper wall 62 in which the laser beam passage 65 is formed as mentioned above, a side wall 63 formed so as to depend from the upper wall 62, and a lower wall 64 opposed to the upper wall 62 and having an opening 68 for capturing the debris D.

There is defined in the debris capturing chamber 61 a capturing space 69 for the debris D, wherein the capturing space 69 is in communication with the laser beam passage 65. The air discharge port 66 and the suction port 67 are formed in the side wall 63 of the debris capturing chamber 61 so as to be opposed to each other with the capturing space 69 defined therebetween. The air discharge port 66 is formed in the side wall 63 at a portion on the trailing side (left side as viewed in FIG. 4) of the feeding direction (shown by an arrow X1 in FIG. 4) of the chuck table 11, whereas the suction port 67 is formed in the side wall 63 at a portion on the leading side (right side as viewed in FIG. 4) of the feeding direction of the chuck table 11. In this manner, the air discharge port 66 and the suction port 67 are opposed to each other in the capturing space 69, so that an air flow is produced in the capturing space 69 so as to travel in the same direction as the feeding direction of the chuck table 11.

The air discharge port 66 is in communication with an air supply passage 71, which is connected to the air supply source 59 through a connecting portion 72 of an air pipe projecting from one outer side surface of the side wall 63. The suction port 67 extends obliquely upward from the opening 68 of the lower wall 64 and is connected through an air pipe (not shown) to a vacuum source 74. This air pipe is connected to a connecting portion 73 projecting from another outer side surface of the side wall 63. The air discharged from the air discharge port 66 flows across the optical path of the laser beam in a direction perpendicular thereto in the range from the laser beam passage 65 to the opening 68 and is then sucked into the suction port 67. With this arrangement, an air flow is produced along the upper surface of the plate-shaped workpiece W (water-soluble protective film 78), so that the debris D captured in the capturing space 69 is sucked into the suction port 67 as riding the air flow. Thus, the debris D is removed from the plate-shaped workpiece W.

The debris capturing chamber 61 has a size that can cover the periphery of the work point P on the plate-shaped workpiece W. More specifically, the opening 68 for capturing the debris D into the capturing space 69 has a width that can cover the line width of each division line of the plate-shaped workpiece W and a length that can cover the periphery of the work point P on the front and rear sides thereof. Accordingly, when the debris capturing chamber 61 is positioned directly above the work point P, the work point P is covered with the debris capturing chamber 61, so that the debris D can be captured into the capturing space 69 immediately after scattering from the work point P. That is, scattering of the debris D around the work point P can be prevented and the debris D can be well removed from the plate-shaped workpiece W.

Further, the debris capturing chamber 61 has a size that can cover only the periphery of the work point P, thereby removing the debris D scattering only in the periphery of the work point P. Accordingly, the debris D can be removed from the optical path of the laser beam by using a small amount of air, thereby improving the processability to the plate-shaped workpiece W. In other words, the debris capturing chamber 61 has a small size and no large-sized suction equipment is needed to simplify the configuration for removing the debris D. The air discharge port 66 is formed at a vertical position (e.g., 5 mm) near the upper surface of the plate-shaped workpiece W (water-soluble protective film 78), so as to produce an air flow along the upper surface of the plate-shaped workpiece W.

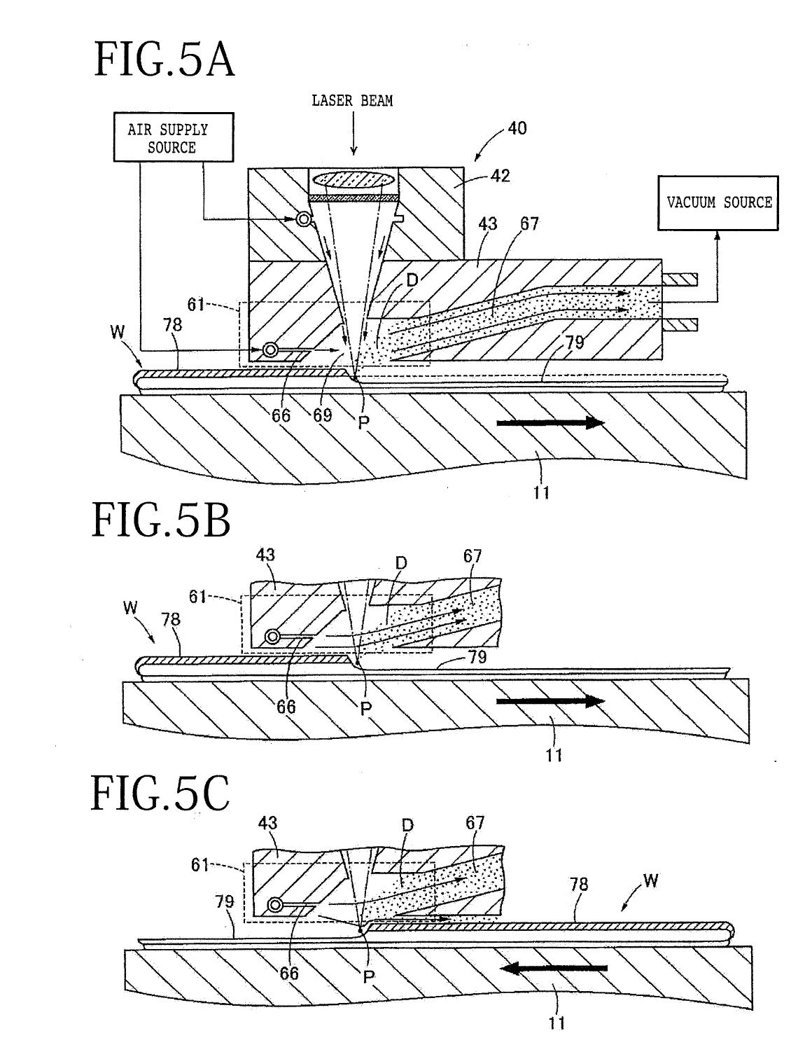

There will now be described a laser processing operation by the processing head 40 with reference to FIGS. 5A to 5C. FIGS. 5A to 5C are sectional views for illustrating a laser processing operation by the processing head 40. More specifically, FIG. 5A shows the laser processing operation according to this preferred embodiment, FIG. 5B shows the laser processing operation in the case that the feeding direction is the same as the discharging direction of air from the air discharge port 66 according to this preferred embodiment, and FIG. 5C shows a comparison wherein the feeding direction is opposite to the air discharging direction.

As shown in FIG. 5A, the processing head 40 is positioned directly above a predetermined one of the division lines of the plate-shaped workpiece W, and the focal point of the laser beam is set inside the plate-shaped workpiece W by the focusing means 42. In operation, the laser beam applied from the processing head 40 is passed through the water-soluble protective film 78 to perform ablation to the plate-shaped workpiece W. In this ablation, the chuck table 11 holding the plate-shaped workpiece W is moved in the feeding direction shown by an arrow X1 in FIG. 5A to thereby form a processed groove 79 on the upper surface of the plate-shaped workpiece W along this predetermined division line. In this ablation, the plate-shaped workpiece W is melted by the laser beam to produce the debris D at the work point P. However, this debris D is removed by the debris capturing chamber 61 located directly above the work point P.

In the debris capturing chamber 61, an air flow is produced along the upper surface of the plate-shaped workpiece W (water-soluble protective film 78), and another air flow is produced along the optical path of the laser beam so as to be directed from the laser beam passage 65 toward the work point P. The debris D captured into the capturing space 69 of the debris capturing chamber 61 is removed from the optical path of the laser beam by the air flow directed from the air discharge port 66 to the suction port 67. Further, even if the debris D is passed upward through this air flow directed from the air discharge port 66 to the suction port 67, the debris D is returned into the capturing space 69 by the downward air flow discharged from the laser beam passage 65. Accordingly, it is possible to prevent the debris D from entering the focusing means 42, and the debris D can be sucked into the suction port 67.

In this operation, the discharging direction of air from the air discharge port 66 is the same as the feeding direction of the chuck table 11 as shown in FIG. 5B. The upper surface of the plate-shaped workpiece W (water-soluble protective film 78) is present directly below the air discharge port 66 at the time the processed groove 79 has not yet been formed as shown in FIG. 5B. Accordingly, the distance from the air discharge port 66 to the upper surface of the plate-shaped workpiece W is relatively small. As a result, the air discharged from the air discharge port 66 flows along the upper surface of the plate-shaped workpiece W in the area where the processed groove 79 is not formed, so that the air flow along the upper surface of the plate-shaped workpiece W is straightened in the direction from the air discharge port 66 toward the suction port 67. Accordingly, the debris D scattering from the work point P can be immediately sucked into the suction port 67 by the air flow produced directly above the work point P.

In contrast, in the comparison shown in FIG. 5C, wherein the discharging direction of air from the air discharge port 66 is opposite to the feeding direction shown by an arrow X2 in FIG. 5C, the processed groove 79 formed on the upper surface of the plate-shaped workpiece W is present directly below the air discharge port 66. Accordingly, the distance from the air discharge port 66 to the processed groove 79 formed on the upper surface of the plate-shaped workpiece W is relatively large. Accordingly, the air discharged from the air discharge port 66 enters the processed groove 79 to cause a disturbance in air flow by the processed groove 79, so that an air flow is produced so as to travel from the air discharge port 66 to the lower side of the suction port 67. Accordingly, the debris D scattering from the work point P rides this air flow passing through the processed groove 79 and the lower side of the processing nozzle 43, thus scattering around the processing nozzle 43.

In summary, when the debris D is generated during the ablation to the plate-shaped workpiece W, the debris D is captured by the debris capturing chamber 61. In the debris capturing chamber 61, the debris D is sucked into the suction port 67 in the direction perpendicular to the optical path of the laser beam, so that the optical path of the laser beam is not interrupted by the debris D, thereby allowing the continuation of the ablation. Further, an air flow is produced directly above the work point P so as to guide the debris D toward the suction port 67 in the direction perpendicular to the optical path of the laser beam, so that the debris D can be removed by a small amount of air and the debris D is not left in the processed groove 79 formed on the plate-shaped workpiece W.

### (Test)

A test was conducted in such a manner that the flow rate (L/minute) and the flow velocity (m/second) of air to be discharged from the air discharge port 66 were changed to perform ablation and the debris left on the upper surface of the plate-shaped workpiece was checked. As the air discharge port 66, a single-hole nozzle having a diameter of 1.0 mm and a single-hole nozzle having a diameter of 2.0 mm were used. The air discharge port 66 was set at a height of 5 mm from the upper surface of the plate-shaped workpiece (water-soluble protective film). The test result is shown in Table 1.

TABLE 1

| Air discharge port diameter | Flow rate | Flow velocity | Debris |
|---|---|---|---|
| [φ mm × single hole] | [L/minute] | [m/second] | remained |
| 1.0 | 15 | 320 | Slightly |
| | | | remained |
| 1.0 | 20 | 420 | Slightly |
| | | | remained |
| 1.0 | 25 | 530 | Not |
| | | | remained |
| 1.0 | 30 | 640 | Remained |
| 2.0 | 25 | 280 | Remained |

In the cases that the flow rate was 15 L/minute and the flow velocity was 320 m/second and that the flow rate was 20 L/minute and the flow velocity was 420 m/second, the debris slightly scattered directly above the work point P when the laser beam was applied, due to the low flow velocity of air. As a result, the laser beam was interrupted by the debris scattered and the power of the laser beam could not be effectively used for the ablation, so that the processed groove 79 was shallow. In the case that the flow rate was 25 L/minute and the flow velocity was 530 m/second, no debris scattered above the plate-shaped workpiece. However, in the case that the flow rate was 25 L/minute and the flow velocity was 280 m/second, the debris scattered above the plate-shaped workpiece and remained thereon. This result shows that the flow velocity of air rather than the flow rate of air is important in removing the debris.

Further, in the case that the flow rate was 30 L/minute and the flow velocity was 640 m/second, the processed groove 79 of the plate-shaped workpiece was shallow. This may be due to the following reason. The debris was blown by the blast of air. However, since the flow rate of air supplied to the suction port 67 was greater than the flow rate of air sucked into the suction port 67, the debris captured by the debris capturing chamber 61 could not be completely sucked, but was left in the debris capturing chamber 61. As a result, the laser beam was interrupted by the debris left in the debris capturing chamber 61. Accordingly, the flow velocity of air to be discharged from the air discharge port 66 is preferably set in the range of 500 m/second to 600 m/second.

Further, the present inventor examined the relation between the flow rate of air to be discharged from the air discharge port 66 and the flow rate of air to be sucked into the suction port 67, and then found that the condition of the air flow might be changed according to the balance between the flow rate of air by the air discharge port 66 and the flow rate of air by the suction port 67, causing a phenomenon that the debris stayed near the position directly above the work point P. For example, in the case that the flow rate of air by the air discharge port 66 was 25 L/minute and the flow rate of air by the suction port 67 was 150 L/minute to 250 L/minute, no debris stayed near the position directly above the work point P. In contrast, when the flow rate of air by the air discharge port 66 was 30 L/minute and the flow rate of air by the suction port 67 was 150 L/minute to 250 L/minute, the debris stayed near the position directly above the work point P. Accordingly, it is preferable to adjust the balance between the flow rate of air by the air discharge port 66 and the flow rate of air by the suction port 67, in order to prevent the stay of the debris directly above the work point P (in order to ensure a proper flow velocity).

As described above, the laser beam is applied through the laser beam passage 65 of the processing nozzle 43 to the upper surface of the plate-shaped workpiece W, and the air is discharged from the air discharge port 66 in the direction perpendicular to the optical path of the laser beam in the debris capturing chamber 61. The air discharged from the air discharge port 66 flows across the optical path of the laser beam in the range from the laser beam passage 65 to the opening 68 of the lower wall 64. Accordingly, an air flow is produced along the upper surface of the plate-shaped workpiece W so as to be directed from the air discharge port 66 toward the suction port 67. The debris scattering from the plate-shaped workpiece W due to the application of the laser beam is sucked into the suction port 67 by this air flow, so that the optical path of the laser beam is not interrupted by the debris in the debris capturing chamber 61. Accordingly, the beam power or the number of passes of the laser beam is not required to be increased, thereby improving the processability. Further, the periphery of the work point P is covered with the debris capturing chamber 61, and the debris is sucked near the periphery of the work point P, so that the debris does not scatter around the processing nozzle 43.

The present invention is not limited to the above preferred embodiment, but various modifications may be made. In the above preferred embodiment, the size, shape, and so on shown in the attached drawings are merely illustrative and they may be suitably changed within the scope where the effect of the present invention can be exhibited. Further, various modifications may be made without departing from the scope of the object of the present invention.

For example, while the air discharging direction by the air discharge port 66 is the same as the feeding direction of the chuck table 11 in the above preferred embodiment, the air discharging direction may be made different from the feeding direction of the chuck table 11, provided that the debris can be suitably sucked into the suction port 67. For example, the air discharging direction may be inclined so as to obliquely intersect the feeding direction of the chuck table 11.

Further, while air is discharged from the laser beam passage 65 of the processing nozzle 43 along the optical path of the laser beam in the above preferred embodiment, this configuration may be omitted. That is, it is only essential that air must be discharged from the air discharge port 66 toward the suction port 67 in the processing nozzle 43.

As described above, the present invention can exhibit the effect that the processability can be improved without increasing the beam power or the number of passes of a laser beam, and the present invention is particularly useful as a laser processing apparatus including a processing nozzle for removing debris.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus for applying a laser beam to an upper surface of a plate-shaped workpiece, thereby performing ablation, the upper surface of the plate-shaped workpiece being covered with a water-soluble protective film, the laser processing apparatus comprising:
a chuck table for holding the plate-shaped workpiece;
focusing means for focusing the laser beam to the plate-shaped workpiece held on the chuck table; and
a processing nozzle for applying the laser beam focused by the focusing means to the upper surface of the plate-shaped workpiece in a direction perpendicular thereto and removing debris from the upper surface of the plate-shaped workpiece;
the processing nozzle including:
a laser beam passage for allowing the pass of the laser beam focused by the focusing means and the application of the laser beam to the upper surface of the plate-shaped workpiece in the direction perpendicular thereto; and
debris removing means for removing the debris scattering from the plate-shaped workpiece due to the application of the laser beam passed through the laser beam passage;
the debris removing means including:
a debris capturing chamber composed of an upper wall in which the laser beam passage is formed, a side wall formed so as to depend from the upper wall, and a lower wall opposed to the upper wall and having an opening for capturing the debris;
a suction port for connecting the debris capturing chamber to a vacuum source; and
an air discharge port for discharging air toward the suction port in such a manner that the air flows across the optical path of the laser beam in a direction perpendicular thereto in the range from the laser beam passage to the opening;
whereby the air is discharged from the air discharge port and the debris is sucked into the suction port by an air flow produced in the debris capturing chamber.

2. The laser processing apparatus according to claim 1, wherein the air is discharged from the air discharge port at a flow velocity of 500 m/second to 600 m/second.
